(19) United States
(12) Patent Application Publication
(10) Pub. No.: US 2008/0120532 A1
(43) Pub. Date: May 22, 2008

(54) Method for the common display of flow charts

(75) Inventors: Ronald Lange, Furth (DE); Michael Schlosser, Schwabach (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT

(21) Appl. No.: 11/986,034

(22) Filed: Nov. 19, 2007

(30) Foreign Application Priority Data
Nov. 20, 2006 (EP) 06024035.5

(51) Int. Cl. G06F 15/00

(52) U.S. Cl. 715/215

(57) ABSTRACT

There is described a system and method, with which a common data model/data file is used for different description formats of processes. The corresponding display is generated by interpreting the data model. It is thus possible to change to the different display formats by means of a view switch.

### CROSS REFERENCE TO RELATED APPLICATIONS

This application claims priority of European Patent Office application No. 06024035.5 EP filed Nov. 20, 2006, which is incorporated by reference herein in its entirety.

### FIELD OF INVENTION

The invention relates to a system and method for the common display of flow charts.

### BACKGROUND OF INVENTION

A problem underlying the invention is the data exchange within the engineering chain in the case of system planning in the industrial environment. This concerns in particular the transfer between the digital production planning (mechanical construction, robot cell planning) and control engineering (see FIG. 1).

The system layout is at the forefront in mechanical construction. This information enables data relating to control engineering (SPS programming, HMI, . . . ) to be partially generated. This data transfer is addressed for instance by the product SIMATIC Automation Designer (see FIG. 2).

In addition to producing the system layout, the mechanical designer also produces a process description. This is typically produced using a pulse timing diagram (operating sequence diagram) (See FIG. 3).

In addition to the pulse timing diagrams, Gantt diagrams are also used to describe the process; this is common particularly in the case of robot cell planning (See FIG. 4). In contrast the control engineer typically describes processes using Sequential Function Charts (SFC, see FIG. 5).

The basic problem is that all descriptions describe the system process but a data exchange is difficult, if not impossible, due to the different display mode. The problem of “round trips” is particularly serious; in other words when a SPS engineer has produced, supplemented or modified a SFC on the basis of the specifications of the mechanic (pulse timing diagram), it is difficult to convert these modifications back to the pulse timing diagram due to the different description methods.

The following solutions for the problem are known:
Manual transformation from one description format to the other by means of intellectual performance. It is not possible to verify by machine whether the two descriptions are consistent with one another. Subsequent modifications are similarly problematic.
Generators: Target system-specific code is directly generated from the general process description. This is implemented for instance with the product eM-PLC, in which SIMATIC S7-specific code is directly generated from the Gantt diagram (see FIG. 6)

This solution is disadvantageous on the one hand in that modifications by the control engineer do not flow back into the process description of the robot cell planning, and on the other hand in that target system-specific code, which is not understandable to the mechanic for instance, is directly generated. A further disadvantage is that even with robot cell planning, more than Gantt diagrams alone are used. The information described by additional pulse timing diagrams must thus also be incorporated (manually) into the SPS code.

### SUMMARY OF INVENTION

An object of the present invention thus consists of specifying a method and a system, which allows an easier data exchange between the applications describing the system.

The object is achieved by the subject matter of independent claims.

The current prior art relating to the aforementioned problem can be set out as follows. The different types of display for processes define their own data model. The transfers are realized using generators. This (unidirectional) generator step is referred to as a download for the target system, since the transfer to a target system-specific voice is carried out here (e.g. to a SIMATIC S7) (see FIG. 7).

The knowledge underlying the invention is that a common data model can be defined for different display formats. The particular advantage of using this knowledge is that the different types of display are then only different presentations (views) of this common data model, thereby allowing a loss-free switch between these views (even following modifications).

In the present application, the description of the automatic operation is cited by way of example, the concept can however be transferred to the description of the manual operation, synchronization operation and further conceivable scenarios.

### BRIEF DESCRIPTION OF THE DRAWINGS

The invention is described and explained in more detail below with reference to the exemplary embodiments illustrated in the figures, in which;

FIG. 1 shows a display of the engineering process,

FIG. 2 shows the data transfer from system layout to control engineering,

FIG. 3 shows an example of a pulse timing diagram,

FIG. 4 shows an example of a Gantt diagram,

FIG. 5 shows an example of the display of the control processes in a Sequential Function Chart (SFC),

FIG. 6 shows an example of the generation of target system-specific code,

FIG. 7 shows a display of the known prior art,

FIG. 8 shows a schematic display of the method and system for the common display of flow charts,

FIG. 9 shows a data exchange via import and export,

FIGS. 10-13 show a display of an exemplary embodiment

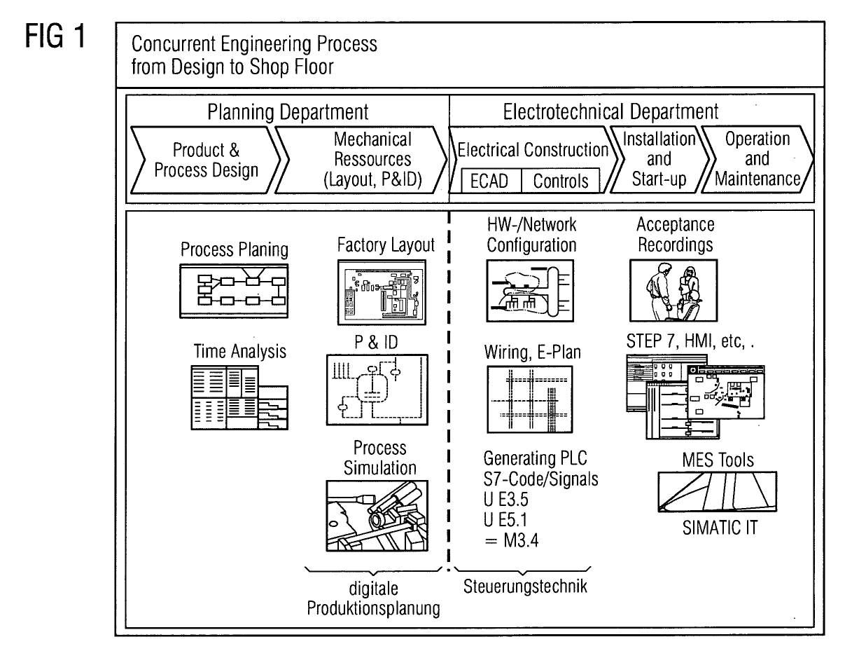

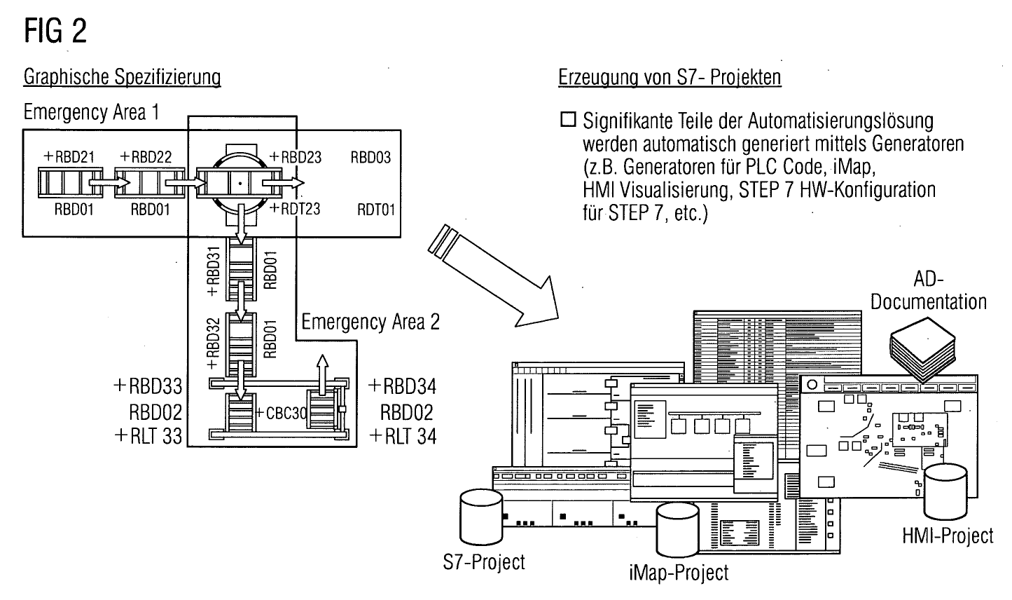

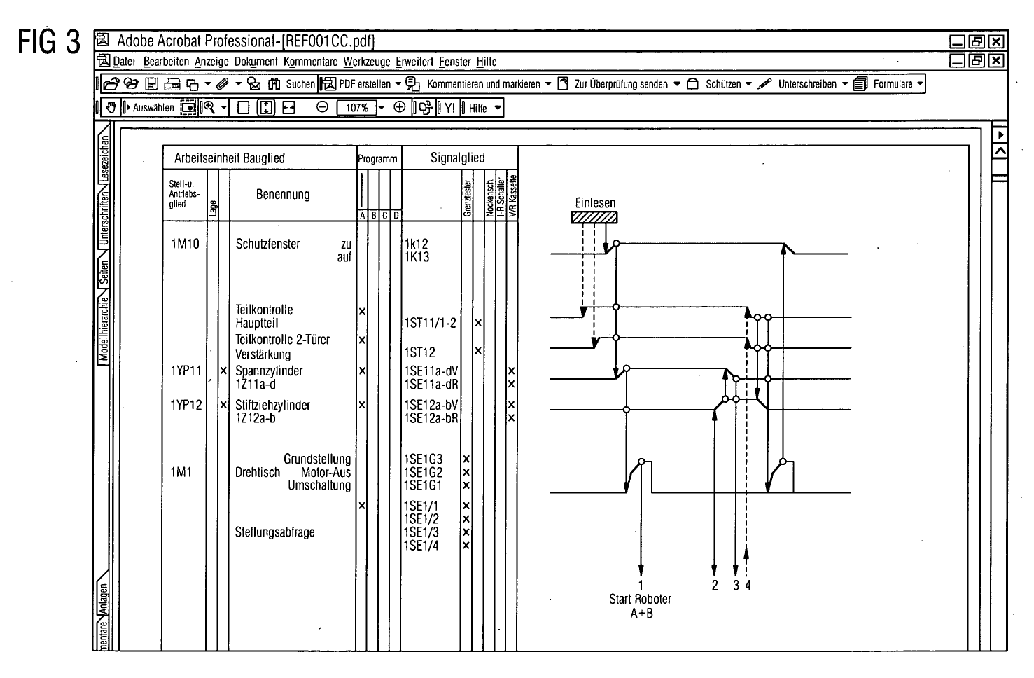

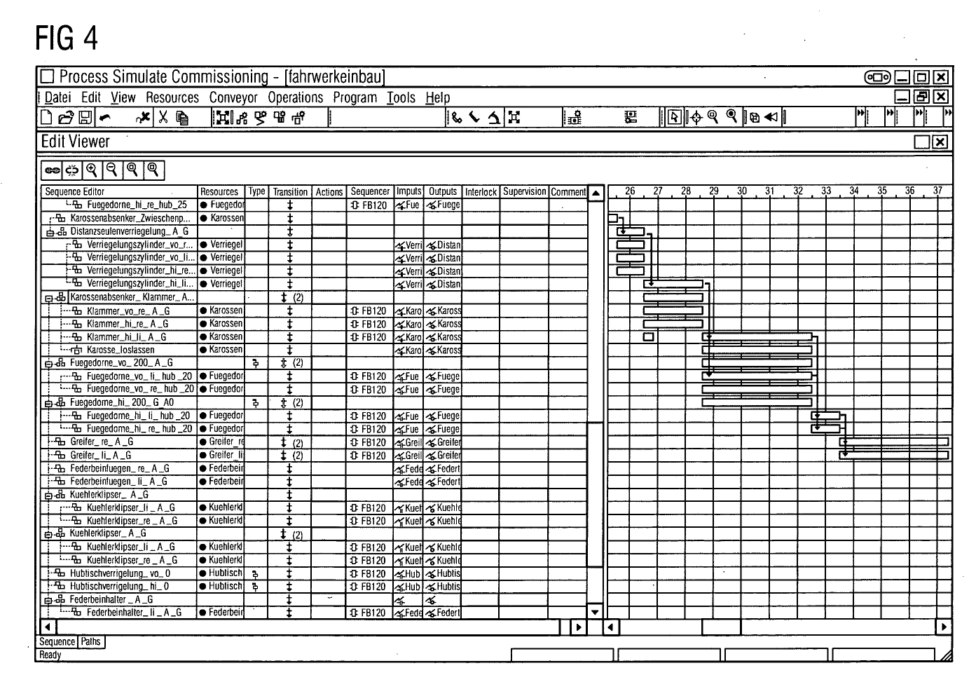

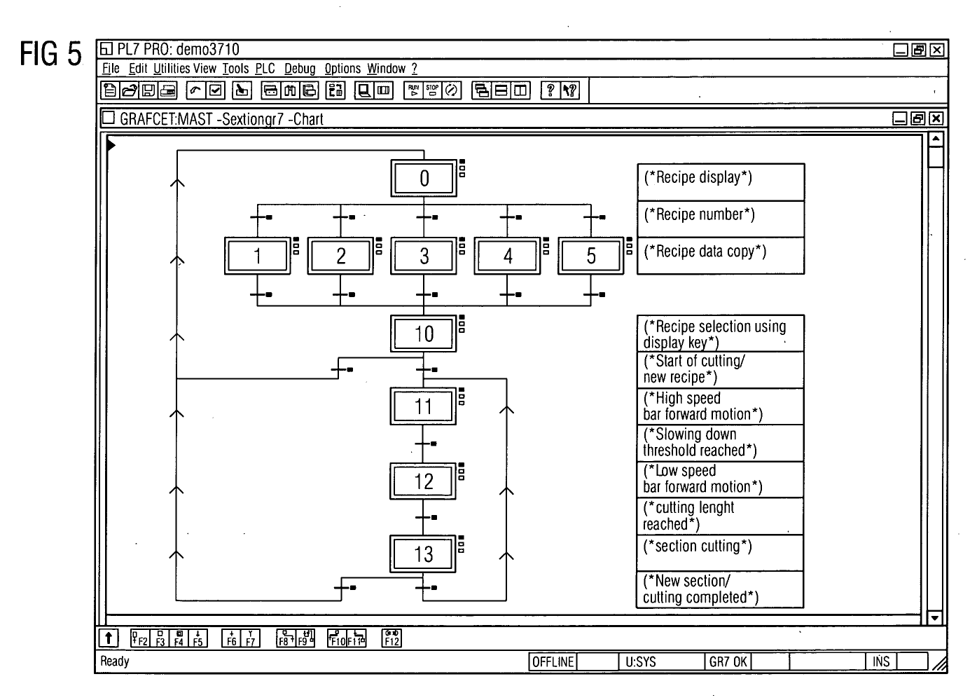

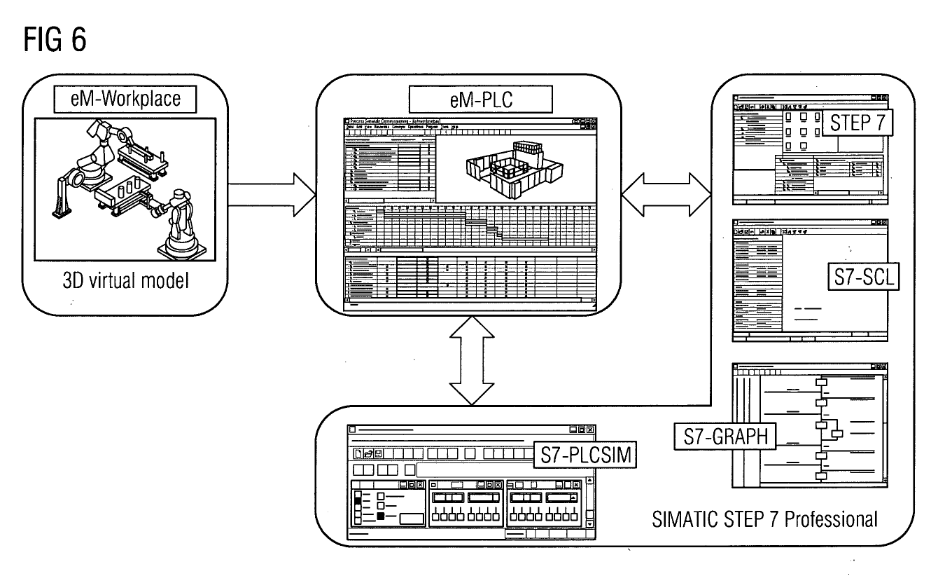

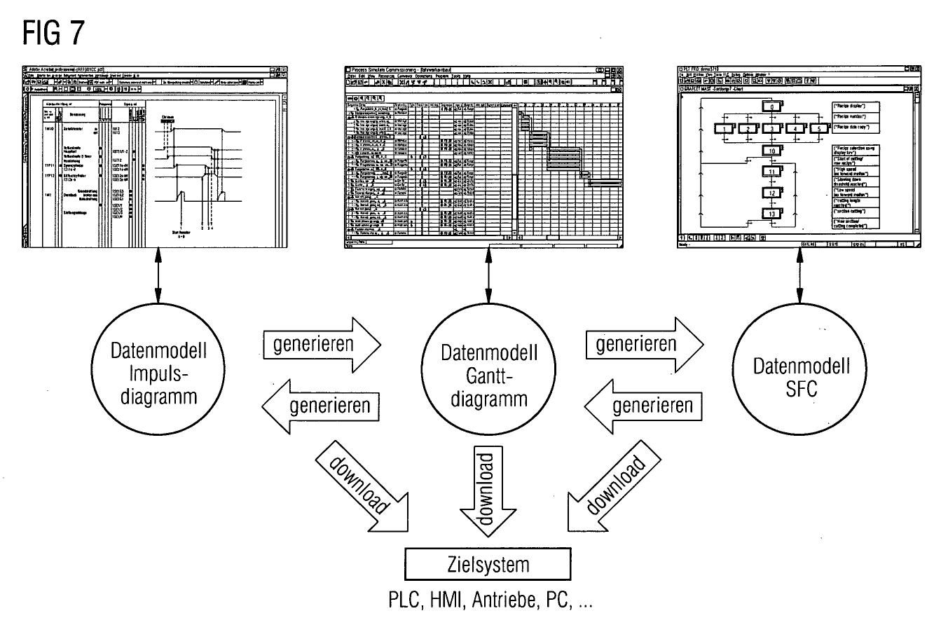

### DETAILED DESCRIPTION OF INVENTION

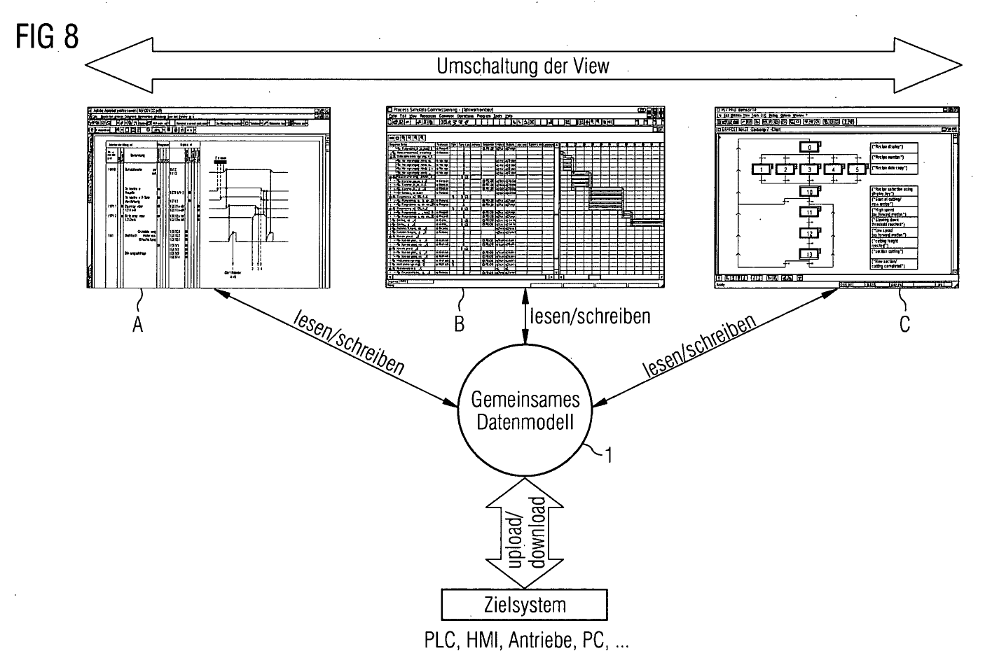

FIG. 8 shows this basic idea of the invention: A common data model/data file 1 is used for different description formats of the process A, B, C (at least 2). The corresponding display is generated by interpreting the data model 1. It is thus possible to switch between the different display formats by means of a view switch.

A modification in one view is thus immediately taken into account in the other views, no generation is necessary. Depending on characteristics of the views, not all information from the common data model needs to be shown. As the modifications are however immediately incorporated into the common data model 1 (no view-specific data management thus exists), no inconsistencies can arise as a result. Target system-specific code can be generated from the common data model 1 by means of a generator. It is also possible to upload the common data model back from the target system-specific code. This invention is advantageous in that different views can be displayed following generation of the common data model. With the prior art, the data format of a pulse timing diagram would be generated for instance but can only be visualized in the pulse timing diagram display. A different visualization requires a generation step.

A further disadvantage with the prior art is that data is potentially lost by the generation steps, since the target format is not able to display an item of data or is only able to display it imprecisely. With the invention, this data loss only relates to the view, i.e. in many displays certain items of data can not be displayed or can only be displayed imprecisely. This therefore does not constitute a real data loss, since the actual data is still present in the common data model and is also displayed accordingly in the event of a view switch (in the views which display this data).

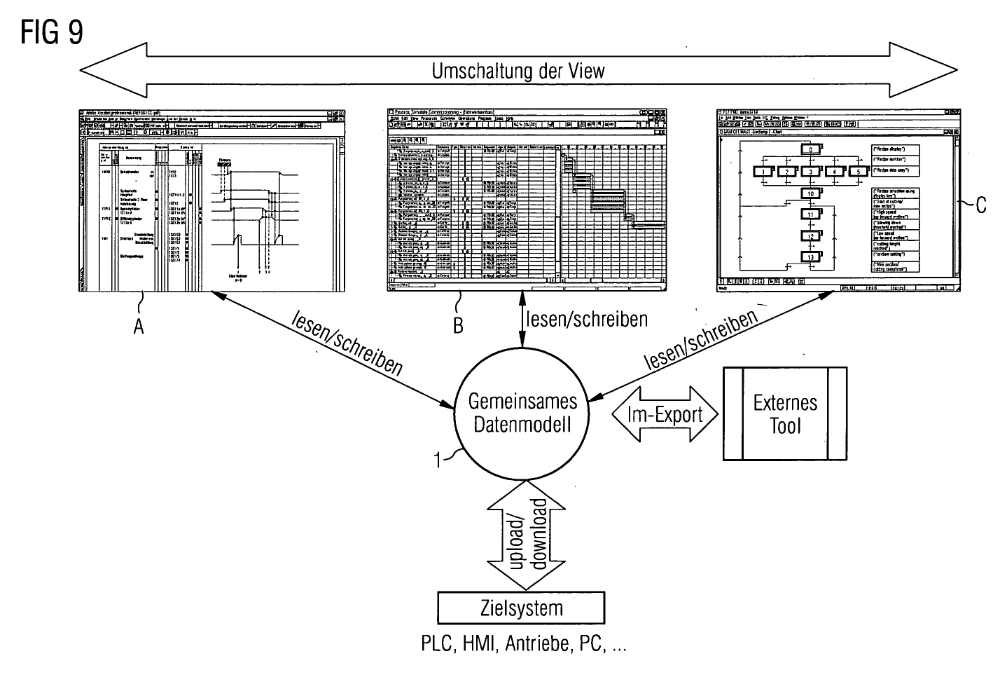

A further advantageous embodiment of the invention is shown in FIG. 9. The suitability of the common data model as an exchange format is shown here. It is possible as a result to exchange data via import/export using an external tool, without it having to be known in which view the data is to be visualized. With the prior art, as with the upload, the data format of a pulse timing diagram is imported/exported for instance, this can however only be visualized in the pulse timing diagram display. A different visualization requires a generation step.

Exemplary embodiment:

The common model consists of

steps with actions
transitions with transfer conditions and a subsequent step

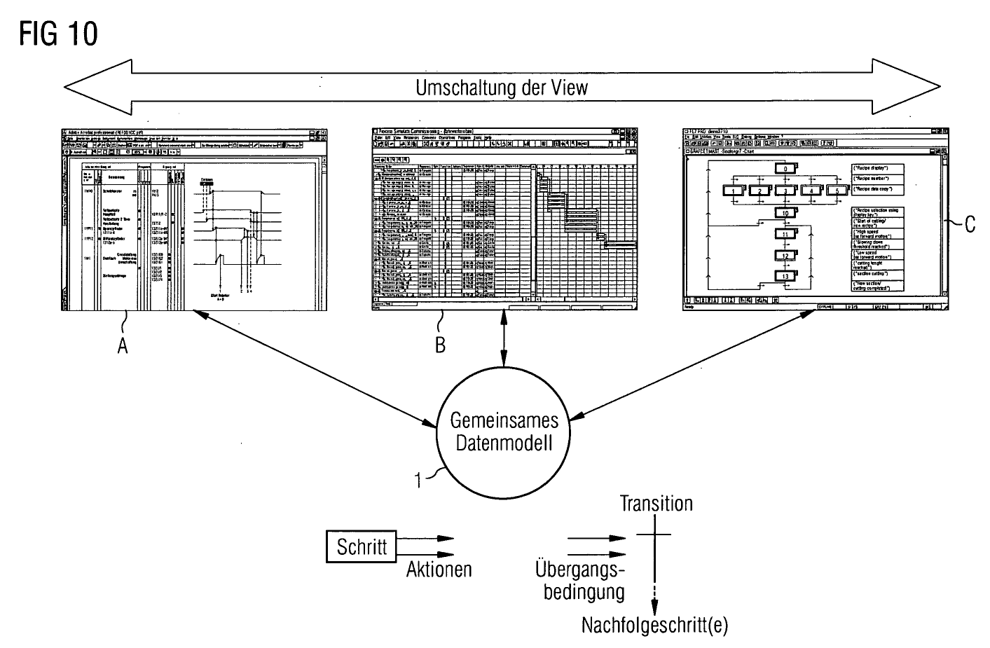

The mapping of this model onto the pulse timing diagram, Gantt, and SFC displays is shown below in FIGS. 10 to 13. Extensions toward status graphs or further process descriptions are possible.

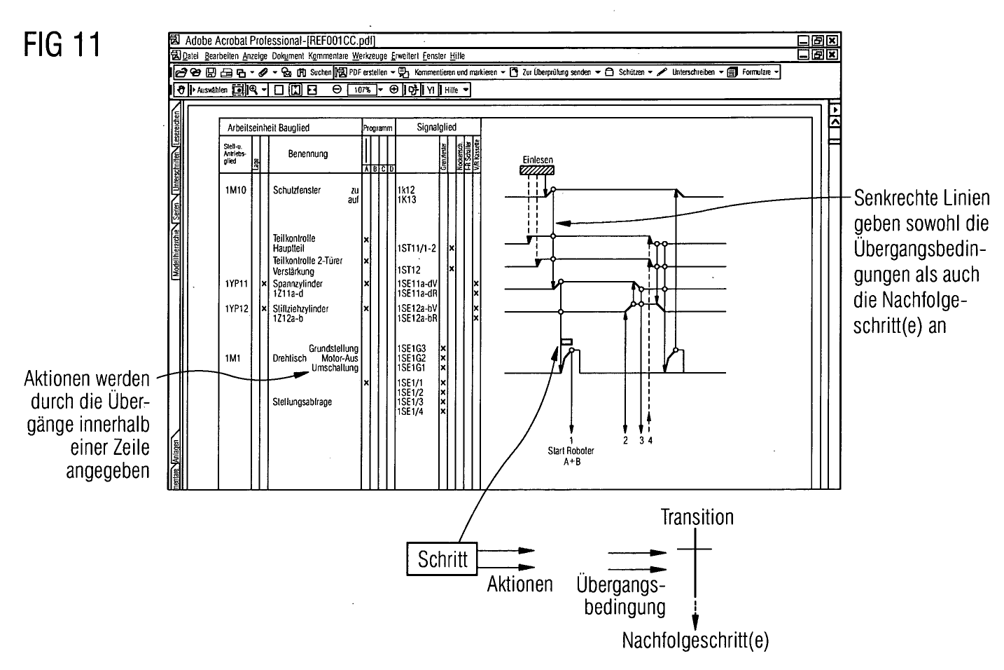

FIG. 11 specifies actions by the transfers within a line. Vertical lines specify both the transfer conditions and also the subsequent step(s).

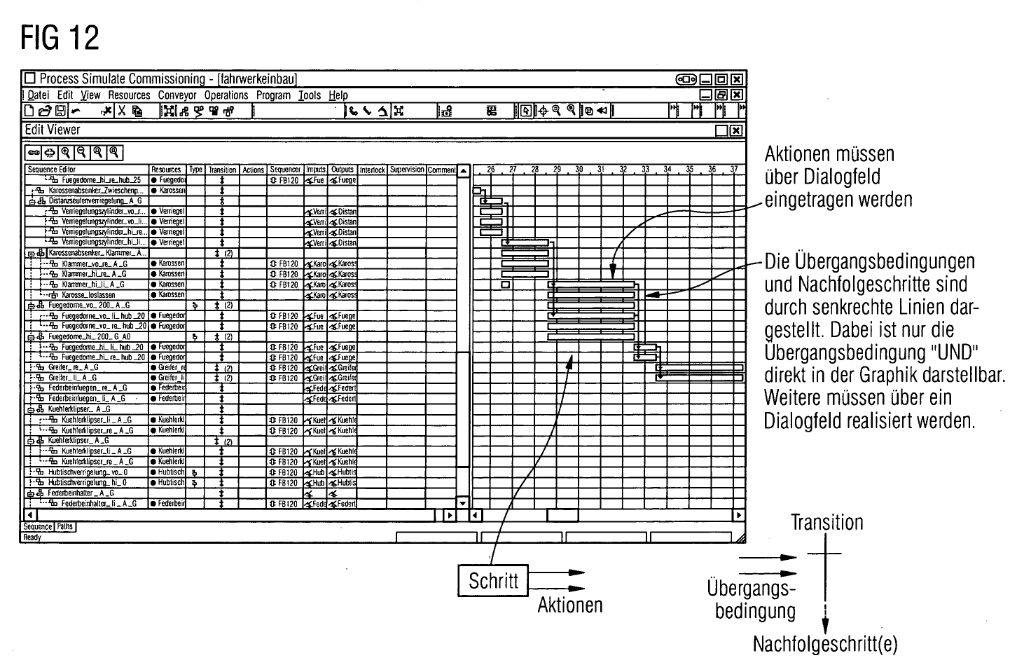

FIG. 12 shows that actions are input via a dialog field. The transfer conditions and subsequent steps are shown by means of vertical lines. In this way, only the transfer condition “AND” can be directly displayed in the graphics. Further transfer conditions must be realized via a dialog field.

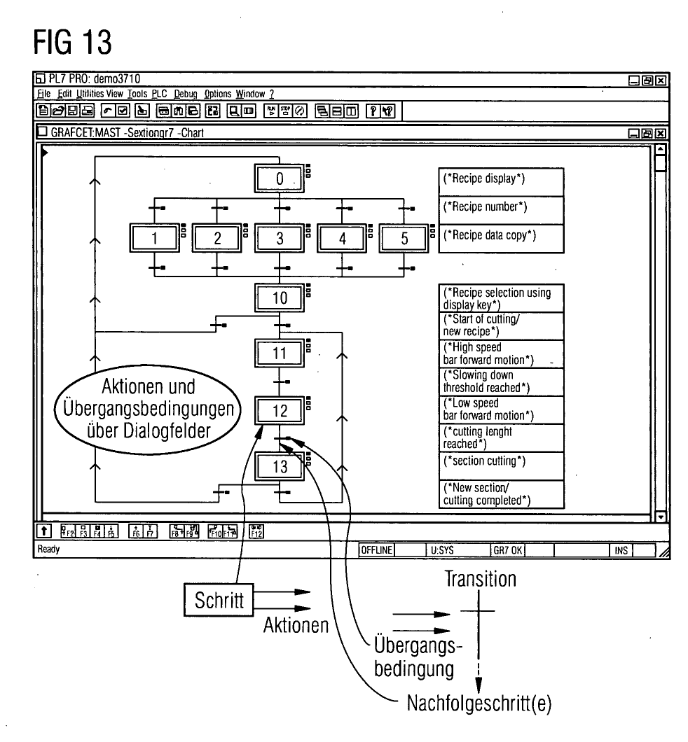

In FIG. 13, actions and transfer conditions are input via dialog fields.

1.-7. (canceled)

8. A method for a common display of flow charts, comprising:
using a common data model for different description formats of a process; and
generating a display of data in a respective flow chart based on an interpretation of the data model.

9. The method as claimed in claim 8, wherein a change to different display formats is based on a view switch.

10. The method as claimed in claim 9, wherein a modification in a first view is immediately taken into account in a second view.

11. The method as claimed in claim 8, wherein the common data model is used as an exchange format, wherein data are exchanged by an import of an export using an external tool, and wherein a view in which the data are to be visualized is unknown.

12. The method as claimed in claim 8, wherein the common data model consists of steps with actions and transitions with transfer conditions and a subsequent step.

13. A system for a common display of flow charts, comprising:
a common data model for different description formats of a process;
a first flow chart generated based on an interpretation of the common data model;
a second flow chart generated based on an interpretation of the common data model; and
a switch to change a display format from the first flow chart to the second flow chart.

14. The system as claimed in claim 13, wherein the common data model is an exchange format, and wherein data is exchanged by an data import of an data export independently from the display format of the data.

15. The system as claimed in claim 14, wherein the common data model consists of steps with actions and transitions with transfer conditions and a subsequent step.

16. A method for a common display of flow charts, comprising:
a pulse timing diagram;
a Gantt diagram;
a Sequential Function Chart;
a common data model for the pulse timing diagram, the Gantt diagram and the Sequential Function Chart, wherein the pulse timing diagram, the Gantt diagram and the Sequential Function Chart are different description formats of a process; and
a switching between display formats of the different description formats based on the common data model.

17. The method as claimed in claim 16, wherein not all information from the common data model is shown in each of the display formats.

18. The method as claimed in claim 17, wherein changes of the process are incorporated in the common data model.

19. The method as claimed in claim 16, wherein the common data model is uploaded from a target system-specific code, wherein the target system-specific code is dependent on one of the display formats.
